(19) United States
(12) Patent Application Publication
(10) Pub. No.: US 2013/0159843 A1
(43) Pub. Date: Jun. 20, 2013

(54) Methods, Apparatuses, Systems, and Computer Readable Media for Copying Contents from a Layout File

(71) Applicants: PEKING UNIVERSITY FOUNDER GROUP CO., LTD., Beijing (CN); BEIJING FOUNDER APABI TECHNOLOGY LTD., Beijing (CN)

(72) Inventors: Wei WAN, Beijing (CN); Chao LEI, Beijing (CN); Xiaolei LI, Beijing (CN); Chao QU, Beijing (CN)

(73) Assignees: BEIJING FOUNDER APABI TECHNOLOGY LTD., Beijing (CN); PEKING UNIVERSITY FOUNDER GROUP CO., LTD., Beijing (CN)

(21) Appl. No.: 13/722,725

(22) Filed: Dec. 20, 2012

(30) Foreign Application Priority Data
Dec. 20, 2011 (CN) 201110430652.5

(51) Int. Cl. G06F 17/21

(52) U.S. Cl. CPC G06F 17/211
USPC 715/248

(57) ABSTRACT

Methods, apparatuses, and computer readable media are disclosed for processing content information in an online environment. The method may comprise receiving a request for a copying operation to copy displayed contents in a selected area of a display page. The request may include area information associated with the selected area and page identification information associated with the display page. The method may also comprise obtaining a layout page in a layout file stored on a server based on the received page identification information, the layout page corresponding to the display page. The method may further comprise searching contents corresponding to the displayed contents in the obtained layout page based on the area information and sending the contents to a client for performing the copying operation.

### CROSS REFERENCE TO RELATED APPLICATIONS

The present application claims the benefits of priority to Chinese Patent Application No. 201110430652.5, filed on Dec. 20, 2011, the entire contents of which are incorporated herein by reference.

### TECHNICAL FIELD

The present disclosure relates to computer information processing technologies, more specifically, to methods, apparatuses, systems, and computer readable media for online copying contents from a layout file.

### BACKGROUND

With the development of information technologies, digital publications have gradually gained popularity. Digital publications, such as electronic books (e-book), often contain digital information in a layout. Some types of layout can offer a display style similar to a paper book, which may provide enhanced reading experience to a user. Some e-book file formats, such as “.ceb,” “.cebx,” and “.pdf' formats, support a paper-like layout.

When a user reads an e-book in an online environment, the contents of the e-book may not be allowed for copying due to, for example, copyright concerns. When copying is allowed, the contents are often copied in the unit of pages. It is therefore desirable to provide a method to allow a user to copy a portion of a page to improve flexibility.

### SUMMARY

One embodiment of the invention involves a method for processing content information in an online environment. The method comprises: receiving, by a processor of a server, a request for a copying operation to copy displayed contents in a selected area of a display page, the request including area information associated with the selected area and page identification information associated with the display page; obtaining, by the processor, a layout page in a layout file stored on the server based on the received page identification information, the layout page corresponding to the display page; searching, by the processor, contents corresponding to the displayed contents in the obtained layout page based on the area information; and sending the contents to a client for performing the copying operation.

Another embodiment of the invention involves a method for processing content information in an online environment. The method comprises: receiving, by a processor of a client, a display page from a server; receiving, by the processor, an inquiry for copying displayed contents in a selected area of the display page; determining, by the processor, area information associated with the selected area and page identification information associated with the display page; sending, by the processor, a request for a copying operation to the server, the request including the area information and the page identification information; and receiving, by the processor, a response from the server for performing the copying operation.

Another embodiment of the invention involves an apparatus for processing content information in an online environment. The apparatus comprises a processor and a memory communicatively connected with the processor. The processor is configured to: receive a request for a copying operation to copy displayed contents in a selected area of a display page, the request including area information associated with the selected area and page identification information associated with the display page; obtain a layout page in a layout file stored in the memory based on the received page identification information, the layout page corresponding to the display page; search contents corresponding to the displayed contents in the obtained layout page based on the area information; and send the contents to a client for performing the copying operation.

Another embodiment of the invention involves an apparatus for processing content information in an online environment. The apparatus comprises a processor and a memory communicatively connected with the processor. The processor is configured to: receive a display page from a server; receive an inquiry for copying displayed contents in a selected area of the display page; determine area information associated with the selected area and page identification information associated with the display page; send a request for a copying operation to the server, the request including the area information and the page identification information; and receive a response from the server for performing the copying operation.

Another embodiment of the invention involves a computer readable medium encoded with a program, when executed by a processor, performs a method for processing content information in an online environment. The method comprises: receiving a request for a copying operation to copy displayed contents in a selected area of a display page, the request including area information associated with the selected area and page identification information associated with the display page; obtaining a layout page in a layout file based on the received page identification information, the layout page corresponding to the display page; searching contents corresponding to the displayed contents in the obtained layout page based on the area information; and sending the contents to a client for performing the copying operation.

Another embodiment of the invention involves a computer readable medium encoded with a program, when executed by a processor, performs a method for processing content information in an online environment. The method comprises: receiving a display page from a server; receiving an inquiry for copying displayed contents in a selected area of the display page; determining area information associated with the selected area and page identification information associated with the display page; sending a request for a copying operation to the server, the request including the area information and the page identification information; and receiving a response from the server for performing the copying operation.

The preceding summary and the following detailed description are exemplary only and do not limit the scope of the claims.

### BRIEF DESCRIPTION OF THE DRAWINGS

The accompanying drawings, which are incorporated in and constitute a part of this specification, in connection with the description, illustrate various embodiments and exemplary aspects of the disclosed embodiments. In the drawings:

FIG. 1 is a schematic diagram illustrating an exemplary online contents processing system, consistent with some disclosed embodiments;

FIG. 2 is a flowchart illustrating an exemplary method performed by a server to process an online content copying request, consistent with some disclosed embodiments; and

FIG. 3 is a flowchart illustrating an exemplary method performed by a client to process an online content copying operation, consistent with some disclosed embodiments.

### DESCRIPTION OF THE EXEMPLARY EMBODIMENTS

Reference will now be made in detail to exemplary embodiments, examples of which are illustrated in the accompanying drawings. When appropriate, the same reference numbers are used throughout the drawings to refer to the same or like parts.

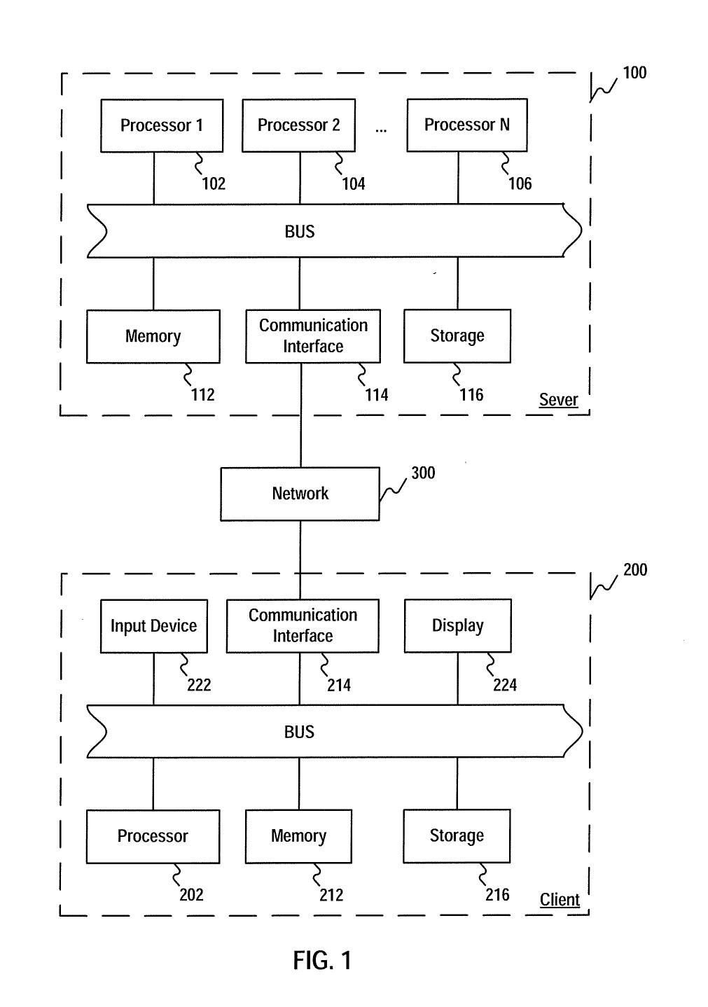

FIG. 1 is a schematic diagram illustrating an exemplary online contents processing system, consistent with some disclosed embodiments. FIG. 1 shows an online environment where a client 200 communicatively connects with a server 100 via a network 300. Information may be exchanged between server 100 and client 200.

Server 100 may include a general purpose computer, a computer cluster, a mainstream computer, a computing device dedicated for providing online contents, or a computer network comprising a group of computers operating in a centralized or distributed fashion. As shown in FIG. 1, server 100 may include one or more processors (processors 102, 104, 106 etc.), a memory 112, a storage device 116, a communication interface 114, and a bus to facilitate information exchange among various components of server 100. Processors 102-106 may include a central processing unit (“CPU”), a graphic processing unit (“GPU”), or other suitable information processing devices. Depending on the type of hardware being used, processors 102-106 can include one or more printed circuit boards, and/or one or more microprocessor chips. Processors 102-106 can execute sequences of computer program instructions to perform various methods that will be explained in greater detail below.

Memory 112 can include, among other things, a random access memory (“RAM”) and a read-only memory (“ROM”). Computer program instructions can be stored, accessed, and read from memory 112 for execution by one or more of processors 102-106. For example, memory 112 may store one or more software applications. Further, memory 112 may store an entire software application or only a part of a software application that is executable by one or more of processors 102-106. It is noted that although only one block is shown in FIG. 1, memory 112 may include multiple physical devices installed on a central computing device or on different computing devices.

In some embodiments, storage device 116 may be provided to store a large amount of data, such as databases containing digital publications, layout files, contents files, multimedia files, etc. Storage device 116 may also store software applications that are executable by one or more processors 102-106. Storage device 116 may include one or more magnetic storage media such as hard drive disks; one or more optical storage media such as computer disks (CDs), CD-Rs, CD±RWs, DVDs, DVD±Rs, DVD±RWs, HD-DVDs, Blu-ray DVDs; one or more semiconductor storage media such as flash drives, SD cards, memory sticks; or any other suitable computer readable media.

Communication interface 114 may provide wired or wireless communication connections such that server 100 may exchange data with other computers, such as client 200. For example, server 100 may be connected to network 300. Network 300 may include a LAN, WAN, VPN, Internet, etc. Client 200 and server 100 may be located in different geographical sites.

Client 200 may include a general purpose computer such as a desktop computer, a laptop computer, etc. Client 200 may also include a portable computer such as a mobile phone, a tablet, or other mobile devices. Client 200 may include a processor 202 such as a CPU, a memory 212 such as a RAM and/or a ROM, a storage device 216, a communication interface 214, an input device 222, a display 224, and a bus to facilitate information exchange among various components of client 200. Storage device 216 may include one or more magnetic storage media such as hard drive disks; one or more optical storage media such as computer disks (CDs), CD-Rs, CD±RWs, DVDs, DVD±Rs, DVD±RWs, HD-DVDs, Blu-ray DVDs; one or more semiconductor storage media such as flash drives, SD cards, memory sticks; or any other suitable computer readable media. Communication interface 214 may include wired and/or wireless communication devices such as an Ethernet adaptor, a WiFi adaptor, a Bluetooth module, a telecommunication module, etc. to connect client 200 to network 300.

In some embodiments, input device 222 and display device 224 may be coupled to processor 202 through appropriate interfacing circuitry. In some embodiments, input device 222 may include a hardware keyboard, a keypad, a mouse, a touchpad, or a touch screen, through which a user may input information to client 200. Display device 224 may include one or more display screens that display media information, such as digital publications, to the user.

Embodiments consistent with the present disclosure provide methods, systems, apparatuses, and computer readable media for copying contents from a layout file in an online environment. An exemplary online environment is shown in FIG. 1, in which server 100 is connected with client 200 via network 300 such that client 200 may fetch multimedia data (e.g., digital publications) from server 100 and display contents of the data on display 224. As used herein, contents refer to subject matter encoded in multimedia data that are readable, viewable, or sensible by a user. For example, contents may include text and/or image contents of an electronic publication, motion picture contents of a movie, audio contents of music or speech, and a combination thereof In some embodiments, client 200 may receive a request from a user (e.g., through input device 222) to obtain digital data from server 100. Client 200 may then send a request for contents to server 100 via network 300. Server 100, upon receiving the request, may obtain the requested contents from a database, in which the contents are contained and/or encoded in layout files. A layout file may include original text, image, video, and/or audio data formatted in a way that is searchable, editable, and/or selectable. For example, when a layout file contains text data, the contents of the text may be encoded in ASCII codes, UTF-8 codes, or any other suitable text coding system that are capable of being searched, edited, and/or selected using a document processing software application. After obtaining the requested contents, server 100, in one embodiment, may choose not to send the contents in a layout file format, but send the requested contents to client 200 in a form of a display file. The display file may be encoded in such a way that it can be processed by client 200 so that the contents contained therein can be displayed on display device 224 for the user to consume, but the user cannot directly copy or edit the contents as plain text data, due to, for example, copyright concerns. For example, the display file may contain text characters that are encoded in an image or other forms of visual formats, which ordinarily do not permit copying or editing operations. If the user wants to copy or edit text contents displayed on display device 224, he may perform such operations by evoking further communications between client 200 and server 100, subject to certain limiting conditions, such as user authorization and/or specific restrictions, related to the text contents.

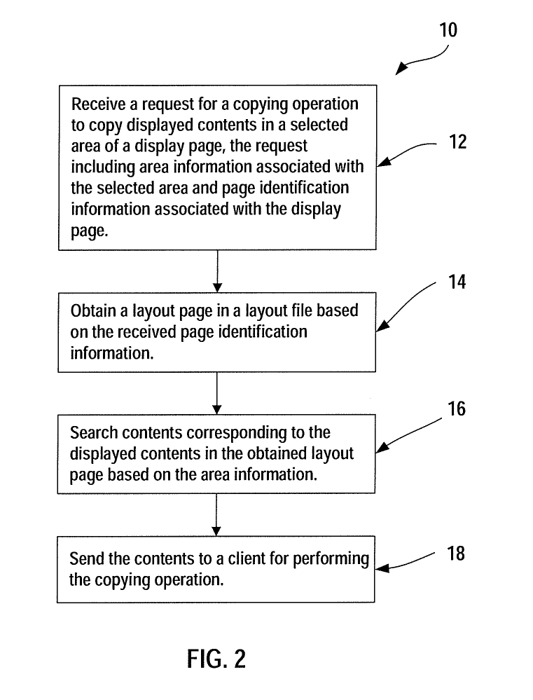

FIG. 2. is a flowchart illustrating an exemplary method performed by a server to process an online content copying request, consistent with disclosed embodiments. In FIG. 2, method 10 comprises a series of steps that may be performed by one or more of processors 102-106 of server 100 to implement a copying operation initiated by a user. The user may start a copying operation by selecting an area enclosing displayed contents to be copied on a display page being displayed on display device 224. Client 200 may communicate with server 100 regarding the copying operation.

In step 12, server 100 may receive a request for the copying operation to copy the displayed contents in the selected area of the display page. The request may include area information associated with the selected area and page identification information associated with the display page. Area information may be any type of information that defines a selected area, such as a starting coordinate and an ending coordinate of the selected area. For example, when the user needs to copy some displayed contents, the user may use a mouse to select a copying area using click-and-drag method. The starting coordinate of the mouse pointer when the user clicks a mouse button can be recorded by client 200. Similarly, the ending coordinate of the mouse pointer when the user releases the mouse can also be recorded by client 200. Therefore, the selected area may be defined by the starting and ending coordinates. The starting and ending coordinates information may then be included in the request by client 200 and subsequently received by server 100.

Page identification information may include a unique identification of the display page being displayed on display device 224. In some embodiments, the display page may be generated by server 100 based on a corresponding layout page in a layout file stored in a database of server 100. Therefore, server 100 may establish a mapping relationship between a particular display page and its corresponding layout page(s). In some embodiments, server 100 may assign a unique identifier for each layout page, and predetermine the relationship between contents contained in a particular layout page and its unique identifier. In some embodiments, server 100 may map the unique identifier of a layout page to a corresponding display page, thereby associating the display page with the contents contained in the layout page(s). In some embodiments, server 100 may assign a unique identification to a display page before sending the display page to client 200 upon request for digital contents. Page identification information of a display page may be permanent or temporary. In one embodiment, page identification information may be contained or encoded into the display page. Once the user initiates a copying operation, page identification information may be extracted or decoded by client 200 and included in the request for copying sent to server 100.

In step 14, server 100 may obtain a layout file stored in the database of server 100 that contains a layout page corresponding to the display page identified by the received page identification information. For example, server 100 may search in the database for the layout file using the page identification information of the display page. Because a mapping relationship between the display page and its corresponding layout page is pre-established, the layout file that contains the layout page corresponding to the display page can be obtained using any suitable searching method.

In step 16, server 100 may search contents contained in the layout file that correspond to the displayed contents in the selected area based on the area information. In one embodiment, the corresponding layout page in the layout file may have the same or similar structure to that of the display page. For example, the layout page and the display page may contain the same number of lines of text on the page and each line may have a same number of words. Therefore, server 100 may identify contents in a layout page that corresponds to the selected area defined by, for example, starting and ending coordinates included in the area information. The identified contents may be extracted from the layout file in response to the copying request of client 200.

In step 18, server 100 may send the contents extracted from the layout file to client 200 for performing the copying operation. Client 200, upon receiving the contents, may perform any necessary decoding procedure before placing the contents on the copying mechanism supported by client 200, such as a “clipboard” or similar software facilities.

In one embodiment, the request sent to server 100 may further include user identification information. User identification information may be any information that identifies a user, such as a user name, password, authorization code, etc. User identification information may be used by server 100 to determine whether the requested copying operation is permitted or not. Server 100 may make the determination by checking the user's credential. For example, server 100 may allow current user to perform the copying operation when the user identification information indicates that all users may perform the copying operation. In another embodiment, server 100 may allow only logged-in users to perform the copying operation and prohibit non-logged-in users to perform the copying operation. Therefore, server 100 may permit or reject the request based on whether the user identification information indicates that the user is logged-in. In another embodiment, server 100 may also permit non-logged-in users to perform the copying operation. In yet another embodiment, server 100 may obtain the layout page only when it is determined that the copying operation is permitted.

In some embodiments, server 100 may determine whether the request of the copying operation satisfies a predetermined copying condition based on the area information, and send the contents to client 200 when the predetermined copying condition is satisfied. The predetermined copying condition may include a maximum number of words, a maximum area, and/or a maximum number of lines. For example, when the predetermined condition includes a maximum number of words, server 100 may determine whether an amount of words contained in the contents extracted from the layout page is greater than the maximum number of words. Server 100 may send the contents to client 200 only when the amount of words contained in the contents is equal to or smaller than the maximum number of words. In another example, the predetermined condition includes maximum area, server 100 may determine whether the selected area is greater than the maximum area. Server 100 may send the contents to client 200 only when the selected area is equal to or smaller than the maximum area. Yet in another example, when the predetermined condition includes a maximum number of lines, server 100 may determine whether an amount of lines contained in the contents is greater than the maximum number of lines. Server 100 may send the contents to client 200 only when the amount of lines contained in the contents is equal to or smaller than the maximum number of lines.

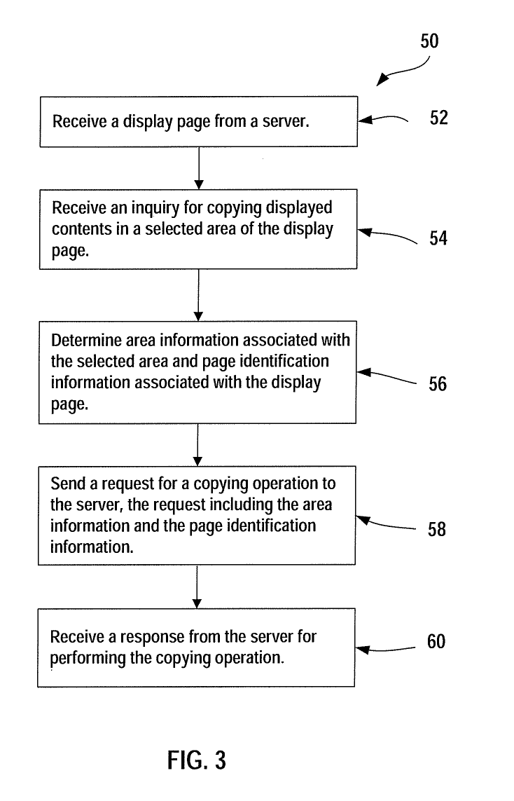

FIG. 3. is a flowchart illustrating an exemplary method performed by a client to process an online contents copying operation, consistent with some disclosed embodiments. In FIG. 3, method 50 comprises a series of steps that may be performed by processor 202 of client 200 to implement a copying operation initiated by a user. In step 52, client 200 may receive a display page from server 100 for displaying to the user. The user may start a copying operation by selecting an area enclosing displayed contents to be copied on the display page being displayed on display device 224. In step 54, client 200 may receive an inquiry for copying the displayed contents in the selected area of the display page from the user. For example, the user may trigger this receiving action by clicking a button of the mouse (e.g., right click) and select option “Copy” after he selects the area. In some embodiments, the user may click a dedicated copy button to trigger the receiving action. In step 56, client 200 may determine area information associated with the selected area and page identification information associated with the display page. As discussed above, the area information may include the starting and ending coordinates and the page information may include a unique identification of the display page. In step 58, client 200 may send a request for the copying operation to server 100. The request may include the area information and the page identification information. In step 60, client 200 may receive the requested contents from server 100 for performing the copying operation.

Embodiment 1

The first embodiment provides a method for online copying content from a layout file. When a server determines to allow a user to online copy text contents of a part of a layout page of a layout file, the server may determine whether a copying area selected by the user satisfies a predetermined copying condition, and if yes, the user may be allowed to copy. The detailed process is as follows.

In step 1, a server may send a display page corresponding to a layout page to a client when the server determines that a user needs to read the contents of the layout page stored on the sever. The client displays the display page to the user using a browser.

In step 1 or before step 1, the server may provide a page identification (PID), which uniquely identifies each page of the layout file, and may preset a corresponding relationship between text content and the PID of each page.

In step 2, the client may send area information regarding an area selected by the user in the currently displayed page and the PID of the page to the server.

In step 3, the server may receive from the client the information of the copying area selected by the user in the currently displayed page and the PID of the page.

In step 4, the server may search for and obtain a layout page corresponding to the PID from the layout file stored therein and may identify text contents corresponding to the copying area in the display page.

Further, in step 4, when the server searches for the text contents to be copied, the server may search for the text contents corresponding to the display page with the certain PID using the preset relationship between the text contents of the layout page and the PID. The server may then search for required text contents in the layout page based on the selected copying area.

In step 5, the server may send the identified text contents to the client.

In step 6, the client may display the received text contents and completes the copying operation.

Further, in step 6, completing the copy operation may comprise parsing the copied text contents and extracting the parsed text contents as the copied contents of the layout file.

The server may preset one or more copying conditions for the text contents in the layout file in order to ensure the settings of permissions for the text contents. For example, a first copying condition for the first paragraph may be set so that the user may copy the first paragraph; a second copying condition for the second paragraph may be set so that the user cannot copy the second paragraph. Alternatively, the copying condition may be set so that the user can or cannot copy a certain word or several words of the text contents. The copying condition may be set so that the user with particular user identification can or cannot perform the copying operation.

### Embodiment 2

The second embodiment provides another method for copying content from a layout file online. When a server determines to allow a user to online copy text contents of a part of a layout page of a layout file, the server may determine whether a copy area selected by the user satisfies a predetermined copying condition corresponding to a user identification (UID) sent from the client. If yes, the user may be allowed to copy. The detailed process is described as follows.

In step A, the server may send a display file corresponding to a layout file to a client when the server determines that the user needs to read the contents of the layout page stored on the sever. The client displays the display file to the user.

When the server stores a layout file, the server may provide a page identification (PID), which uniquely identifies each page of the layout file, and may associate text content with the PID of each page.

In step B, the client may send to the server information of the copying area selected by the user on the currently displayed page, the PID of the page, and the UID.

In step C, the server may receive, from the client, the information of the copying area selected by the user on the currently displayed page, the PID of the page, and the UID.

In step E, the server may determine whether to allow the user to copy the content in the copying area based on the UID.

In one example, the UID may be used to identify that all users may copy. Alternatively, the UID may be used to identify that a logged-in user can copy and a non-logged-in user cannot copy.

Alternatively, the UID may be used to identify that a logged-in user cannot copy and a non-logged-in user can copy.

In this embodiment, the logged-in user can copy, while the non-logged-in user cannot copy.

In step F, when the server determines to allow the user to copy, the server may search for and obtain a layout page corresponding to the PID from the layout file stored therein and may search for text contents corresponding to the copying area of the display page.

When a user desires to copy, the user may select a copying area to be copied by clicking a left mouse button. The client may record the coordinate value where the left mouse button is pressed and the coordinate value where the left mouse button is lifted, select the coordinate value where the left mouse button is pressed as a starting coordinate value, and select the coordinate value where the left mouse button is lifted as an ending coordinate value. Then, the client may use the area determined by the starting and ending coordinate values as the copying area.

When the user decides to copy an area in the current page, he may click a “copy” button in order to ensure the accuracy of the copy. After the client determines that the user clicks the “copy” button, the client may determine whether the starting and ending coordinate values are recorded before the “copy” button is clicked. If not, the client may prompt the user to select a copying area; and if yes, the client may use the area defined by the last record of the starting and ending coordinate values as the required copying area. The client may determine the PID of the page.

In step G, the server may determine a copying condition and may determine whether the copying area satisfies the copying condition. Specifically, step G may comprise the following actions.

For example, based on the UID of the user who is currently reading the display page, the server may determine the maximum number of words defined by the copying condition corresponding to the UID. For example, the server may set the maximum number of words defined by the copying condition corresponding to the UID of a logged-in user to server 100, and sets the maximum number of words defined by the copying condition corresponding to the UID of an non-logged-in user to server 100.

In a second example, based on the UID of the user who is currently reading the display page, the server may determine the maximum area defined by the copying condition corresponding to the UID. For example, the server may set the maximum area defined by the copying condition corresponding to the UID of a logged-in user to 10 cm* 10 cm, and sets the maximum area defined by the copying condition corresponding to the UID of a non-logged-in user to 1 cm*1 cm.

In a third example, based on the UID of the user who is currently reading the display page, the server may determine the maximum number of lines defined by the copying condition corresponding to the UID. For example, the server may set the maximum number of lines defined by the copying condition corresponding to the UID of a logged-in user to 20, and sets the maximum number of lines defined by the copying condition corresponding to the UID of a non-logged-in user to 3.

In step H, when applying the first condition in step G, the server may send the text contents obtained to the client if the server determines that the number of words contained in the copying area is not greater than the maximum number of words.

When applying the second condition in step G, the server may send the text contents obtained to the client if the server determines that the area contained in the copying area is not greater than the maximum area.

When applying the third condition in step G, the server may send the text contents obtained to the client if the server determines that the number of lines contained in the copying area is not greater than the maximum number of lines.

In step I, the server may prompt the user that it is prohibited to copy or selects the area defined by the copying condition as the copying area, in the cases that the server determines the number of words contained in the copying area is greater than the maximum number of words, the area contained in the copying area is greater than the maximum area, or the number of lines contained in the copying area is greater than the maximum number of rows.

In step I, when the server obtains the text content to be copied, the server can search for the text content of the page via the determined PID by the use of the preset corresponding relationship between the text content and the PID of the page and then search for the required text content in the text content via the determined copy area. The server may then send the obtained text content to the client.

In step J, the client displays the received text content and completes the copy operation. The process of the copy operation may comprise: parsing the copied text content and extracting the parsed text content as the copied content of the layout file.

In one preferred embodiment, in order to provide a better protection of permissions of the layout file, it is possible that different copying conditions can be set in detail for different users with different UIDs in step G. For example, it is possible that the logged-in UIDs can be divided into VIP and normal logged-in UIDs, and then different copying conditions can be set for VIP and normal logged-in UIDs, respectively.

In another preferred embodiment, the server can preset a copying condition for the text content in the layout file in order to ensure the settings of permissions for the text content. For example, a first copying condition for the first paragraph may be set so that the user can copy the first paragraph, and a second copying condition for the second paragraph is set so that the user cannot copy the second paragraph. Alternatively, the copying condition can be set so that the user can or cannot copy a word or several words of the text content. And, the copying condition can be set so that the user with a kind of UIDs can or cannot copy.

In another preferred embodiment, in order to display and perform the copy operation more conveniently, it is possible that step G is not performed, such that step H, i.e. sending the text content to the client, is directly performed when the server determines to allow the user to perform copy operation.

In another preferred embodiment, the display file corresponding to the layout file discussed above is a file which can be used to show the original layout of the layout file, such as an image file.

The embodiments of the present invention may be implemented using certain hardware, software, or a combination thereof In addition, the embodiments of the present invention may be adopted to a computer program product embodied on one or more computer readable storage media (comprising but not limited to disk storage, CD-ROM, optical memory and the like) containing computer program codes.

In the foregoing descriptions, various aspects, steps, or components are grouped together in a single embodiment for purposes of illustrations. The disclosure is not to be interpreted as requiring all of the disclosed variations for the claimed subject matter. The following claims are incorporated into this Description of the Exemplary Embodiments, with each claim standing on its own as a separate embodiment of the disclosure.

Moreover, it will be apparent to those skilled in the art from consideration of the specification and practice of the present disclosure that various modifications and variations can be made to the disclosed systems and methods without departing from the scope of the disclosure, as claimed. Thus, it is intended that the specification and examples be considered as exemplary only, with a true scope of the present disclosure being indicated by the following claims and their equivalents.

1. A method for processing content information in an online environment, comprising:
receiving, by a processor of a server, a request for a copying operation to copy displayed contents in a selected area of a display page, the request including area information associated with the selected area and page identification information associated with the display page;
obtaining, by the processor, a layout page in a layout file stored on the server based on the received page identification information, the layout page corresponding to the display page;
searching, by the processor, contents corresponding to the displayed contents in the obtained layout page based on the area information; and
sending the contents to a client for performing the copying operation.

2. The method of claim 1, wherein the request further includes user identification information and the method further comprises:
determining, by the processor, whether the requested copying operation is permitted based on the user identification information; and
obtaining the layout page when the requested copying operation is permitted.

3. The method of claim 1, further comprising:
determining whether the requested copying operation satisfies a predetermined copying condition based on the area information; and
sending the contents to the client when the predetermined copying condition is satisfied.

4. The method of claim 3, wherein the predetermined copying condition includes a maximum number of words and the method further comprises:
determining whether an amount of words contained in the contents is greater than the maximum number of words; and
sending the contents to the client when the amount of words contained in the contents is equal to or smaller than the maximum number of words.

5. The method of claim 3, wherein the predetermined copying condition includes a maximum area and the method further comprises:
determining whether the selected area is greater than the maximum area; and
sending the contents to the client when the selected area is equal to or smaller than the maximum area.

6. The method of claim 3, wherein the predetermined copying condition includes a maximum number of lines and the method further comprises:
determining whether an amount of lines contained in the contents is greater than the maximum number of lines; and
sending the contents to the client when the amount of lines contained in the contents is equal to or smaller than the maximum number of lines.

7. The method of claim 1, wherein the area information includes a starting coordinate and an ending coordinate of the selected area.

8. A method for processing content information in an online environment, comprising:
receiving, by a processor of a client, a display page from a server;
receiving, by the processor, an inquiry for copying displayed contents in a selected area of the display page;
determining, by the processor, area information associated with the selected area and page identification information associated with the display page;
sending a request for a copying operation to the server, the request including the area information and the page identification information; and
receiving a response from the server for performing the copying operation.

9. The method of claim 8, wherein the response includes contents corresponding to the displayed contents in the selected area of the display page.

10. An apparatus for processing content information in an online environment, comprising:
a processor and a memory communicatively connected with the processor; wherein the processor is configured to:
receive a request for a copying operation to copy displayed contents in a selected area of a display page, the request including area information associated with the selected area and page identification information associated with the display page;
obtain a layout page in a layout file stored in the memory based on the received page identification information, the layout page corresponding to the display page;
search contents corresponding to the displayed contents in the obtained layout page based on the area information; and
send the contents to a client for performing the copying operation.

11. The apparatus of claim 10, wherein the request further includes user identification information and the processor is further configured to:
determine whether the requested copying operation is permitted based on the user identification information; and
obtain the layout page when the requested copying operation is permitted.

12. The apparatus of claim 10, wherein the processor is further configured to:
determine whether the requested copying operation satisfies a predetermined copying condition based on the area information; and
send the contents to the client when the predetermined copying condition is satisfied.

13. The apparatus of claim 12, wherein the predetermined copying condition includes a maximum number of words and the processor is further configured to:
determine whether an amount of words contained in the contents is greater than the maximum number of words; and
send the contents to the client when the amount of words contained in the contents is equal to or smaller than the maximum number of words.

14. The apparatus of claim 12, wherein the predetermined copying condition includes a maximum area and the processor is further configured to:
determine whether the selected area is greater than the maximum area; and
send the contents to the client when the selected area is equal to or smaller than the maximum area.

15. The apparatus of claim 12, wherein the predetermined copying condition includes a maximum number of lines and the processor is further configured to:
determine whether an amount of lines contained in the contents is greater than the maximum number of lines; and
send the contents to the client when the amount of lines contained in the contents is equal to or smaller than the maximum number of lines.

16. The apparatus of claim 10, wherein the area information includes a starting coordinate and an ending coordinate of the selected area.

17. A computer readable medium encoded with a program, when executed by a processor, performing a method for processing content information in an online environment, the method comprising:
receiving a display page from a server;
receiving an inquiry for copying displayed contents in a selected area of the display page;
determining area information associated with the selected area and page identification information associated with the display page;
sending a request for a copying operation to the server, the request including the area information and the page identification information; and
receiving a response from the server for performing the copying operation.
